(19) United States
(12) Patent Application Publication
(10) Pub. No.: US 2022/0019800 A1
(43) Pub. Date: Jan. 20, 2022

(54) Directional Guidance and Layout Compliance for Item Collection

(71) Applicant: ZEBRA TECHNOLOGIES CORPORATION, Lincolnshire, IL (US)

(72) Inventors: Chu Pang Alex Ng, Markham (CA); Yi-Hsuan Yeh, Toronto (CA)

(21) Appl. No.: 16/932,198

(22) Filed: Jul. 17, 2020

(51) Int. Cl. G06K 9/00; H04W 4/024; G01C 21/20; G06Q 10/08; G06K 19/06

(52) U.S. Cl. CPC G06K 9/00671; H04W 4/024; G06K 19/06028; G06Q 10/087; G01C 21/206

(57) ABSTRACT

A method in a mobile computing device includes: obtaining order collection data containing (i) item identifiers corresponding to a set of target items and a set of non-target items, (ii) a reference layout indicating, within a region of a facility, respective positions of the target items and the non-target items, and (iii) item recognition data for the target items and the non-target items; controlling an image sensor of the mobile computing device to acquire an image of a portion of the region; based on the item recognition data, detecting an item from the image; when the detected item is a target item, controlling an output assembly of the mobile computing device to present a prompt to collect the detected item; and when the detected item is a non-target item, controlling the output assembly to present a directional guide towards a selected target item based on the reference layout.

### BACKGROUND

Some retailers offer services such as delivery of online orders, or “buy online, pick up in store” (BOPIS), enabling customers to place orders via a network. The orders may then be filled by store staff, and picked up by customers or delivered to customer premises. Items may be collected manually by in-store staff for such services. A given store may contain a wide variety of items, which can render in-store order filling prior to pick up or delivery time-consuming and error-prone.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for item collection guidance.

FIG. 2 is a flowchart of a method for item collection guidance.

FIG. 3 is a diagram illustrating an example performance of block 205 of the method of FIG. 2.

FIG. 4 is a diagram illustrating an example performance of block 210 of the method of FIG. 2.

FIG. 5 is a diagram illustrating an example performance of block 215 of the method of FIG. 2.

FIG. 6 is a diagram illustrating an example performance of blocks 220 and 225 of the method of FIG. 2.

FIG. 7 is a diagram illustrating an example performance of block 225 of the method of FIG. 2.

FIG. 8 is a diagram illustrating an example performance of block 245 of the method of FIG. 2.

FIG. 9 is a diagram illustrating another example performance of blocks 220 and 225 of the method of FIG. 2.

FIG. 10 is a diagram illustrating an example performance of block 250 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a mobile computing device includes: obtaining order collection data containing (i) item identifiers corresponding to a set of target items and a set of non-target items, (ii) a reference layout indicating, within a region of a facility, respective positions of the target items and the non-target items, and (iii) item recognition data for the target items and the non-target items; controlling an image sensor of the mobile computing device to acquire an image of a portion of the region; based on the item recognition data, detecting an item from the image; when the detected item is a target item, controlling an output assembly of the mobile computing device to present a prompt to collect the detected item; and when the detected item is a non-target item, controlling the output assembly to present a directional guide towards a selected target item based on the reference layout.

Additional examples disclosed herein are directed to a computing device, comprising: an image sensor; an output assembly; and a processor configured to: obtain order collection data containing (i) item identifiers corresponding to a set of target items and a set of non-target items, (ii) a reference layout indicating, within a region of a facility, respective positions of the target items and the non-target items, and (iii) item recognition data for the target items and the non-target items; control the image sensor to acquire an image of a portion of the region; based on the item recognition data, detect an item from the image; when the detected item is a target item, control the output assembly to present a prompt to collect the detected item; and when the detected item is a non-target item, control the output assembly to present a directional guide towards a selected target item based on the reference layout.

Further examples disclosed herein are directed to a non-transitory computer readable medium storing computer readable instructions executable by a processor to: obtain order collection data containing (i) item identifiers corresponding to a set of target items and a set of non-target items, (ii) a reference layout indicating, within a region of a facility, respective positions of the target items and the non-target items, and (iii) item recognition data for the target items and the non-target items; control an image sensor to acquire an image of a portion of the region; based on the item recognition data, detect an item from the image; when the detected item is a target item, control an output assembly to present a prompt to collect the detected item; and when the detected item is a non-target item, control the output assembly to present a directional guide towards a selected target item based on the reference layout.

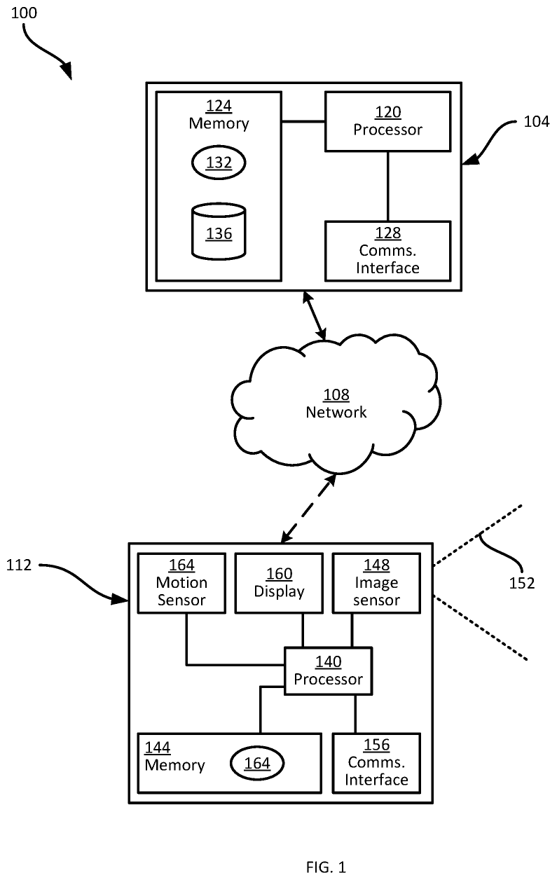

FIG. 1 shows an item collection guidance system 100. The system 100 can be deployed for use in a wide variety of facilities, including retailers (e.g. grocers), warehouses or other transport and logistics facilities, and the like. The system 100 is employed to assist in filling orders for items received from customers or other entities. For example, in the context of a grocer or other retailer, an order may be received from a customer computing device. In particular, the order may be received at a server 104 via a network 108 (e.g. any suitable combination of local and wide area networks, including the Internet). The order may identify at least one item, also referred to herein as a target item. The order may also indicate a desired quantity of the item. As will be apparent, a given order can identify a plurality of target items, which may be at various locations within the facility.

Orders received at the server 104 are deployed to workers in the facility for collection of the target items. Specifically, orders may be allocated to specific workers, and provided to the relevant workers by transmission from the server 104 to mobile computing devices operated by the workers. An example mobile computing device 112, also referred to herein simply as the device 112, is shown in FIG. 1.

The information provided from the server to the device 112 to assist the operator of the device 112 in fulfilling an order can include item identifiers for the target items, as well as location information corresponding to the target items. For example, the facility may contain a plurality of aisles or other regions each comprising a plurality of shelf modules or other support structures carrying items thereon. Which items are placed in which aisle, and the specific locations of such items within the relevant aisle, may be specified in a reference layout, also referred to as a planogram.

The order collection information received by the device 112 from the server 104 may, for example, indicate which aisle each target item is in. However, each aisle may contain a substantial number of items beyond the target item(s) in that aisle. Further complicating the collection of items to fulfill an order, certain items may be misplaced within an aisle, such that the locations of such items does not match the location specified in the above-mentioned planogram. Discovering misplaced products (also referred to as plugs), as well as products that are out of stock and the like, may be a time-consuming task performed manually by workers.

As will be discussed below in greater detail, the server 104 and the device 112 implement functionality to assist or guide a worker to complete item collection for an order. For example, using order information received from the server 104, the device 112 may detect items within a field of view (FOV) of a camera, and provide directional guidance to the operator of the device 112 towards target items based on the detected items. The device 112 may also, during collection of items for an order, detect mismatches between the above-mentioned reference layout and the actual placement of items in the facility.

Certain internal components of the server 104 and the device 112 are also shown in FIG. 1. In particular, the server 104 includes a special-purpose controller, such as a processor 120, interconnected with a non-transitory computer readable storage medium, such as a memory 124. The memory 124 includes a suitable combination of volatile memory (e.g. Random Access Memory or RAM) and non-volatile memory (e.g. read only memory or ROM, Electrically Erasable Programmable Read Only Memory or EEPROM, flash memory). The processor 120 and the memory 124 each comprise at least one integrated circuit.

The server 104 also includes a communications interface 128 enabling the server 104 to communicate with other computing devices via the network 108, including the device 112. The memory 124 stores computer readable instructions for execution by the processor 120. In particular, the memory 124 stores an order tracking application 132 (also referred to simply as the application 132). When executed by the processor 120, the application 132 configures the processor 120 to receive order data (e.g. from a customer), and generate order collection data and deploy the order collection data to the device 112 for use during order fulfillment. The application 132 may also be implemented as a suite of distinct applications in other examples.

The memory 124 also stores a repository 136 containing various reference data for the facility. For example, the repository 136 can contain a planogram, or reference layout, specifying item identifiers and locations for each item in the facility. In other words, the reference layout defines a map of the shelf space for each aisle in the facility. The reference layout can also include or be associated with various item attributes for each item, such as a price, physical dimensions (e.g. weight, volume and the like), and barcode data (e.g. a Universal Product Code (UPC) or the like). The repository 136 can also contain item recognition data, such as classification model parameters employed by a classifier to detect the items from images. Examples of such classifiers include neural networks (e.g. You Only Look Once (YOLO)), and the item recognition data can therefore include node weights and other parameters defining a neural network trained on a set of images representing the products in the facility. Such a classifier can accept as input an image containing one or more items, and identify which items are present in the image (e.g. by generating bounding boxes and associating item identifiers with each bounding box).

The device 112, which may be implemented as a tablet computer, wrist-mounted computer or hand-held device, includes a special-purpose controller, such as a processor 140, which may be interconnected with or include a non-transitory computer readable storage medium such as a memory 144. The processor 140 and the memory 144 can be implemented as at least one integrated circuit. In some examples, the processor 140 and at least a portion of the other components of the device 112 (including the memory 144) can be implemented on a single integrated circuit, e.g. as a system on a chip (SoC).

The device 112 also includes an image sensor 148. The image sensor 148 can include any suitable combination of a camera, a stereo camera assembly (e.g. a pair of synchronized cameras), time-of-flight (ToF) camera, or the like. The image sensor 148 is controllable by the processor 140 to capture image data (e.g. an array of pixels with color information) covering a field of view (FOV) 152.

The device 112 further includes a communications interface 156, enabling the device 112 to communicate with other computing devices via the network 108, including the server 104. For example, the interface 156 can include a suitable combination of transceivers, controllers and the like to establish a link with the network 108.

The device 112 also includes a display 160, controllable by the processor 140 to present data to the operator of the device 112. The device 112 can include other output devices in addition to the display 160, such as a speaker, an indicator light, a motor for haptic feedback, and the like. Such output devices may be collectively referred to as an output assembly. The device 112 can also include an input assembly, which may include any one of, or any combination of, a touch screen integrated with the display 160, a microphone, a keypad, a barcode scanner or other data capture module, or the like.

The device 112 can also include a motion sensor 164, such as an inertial measurement unit (IMU) comprising a combination of accelerometers and gyroscopes. The motion sensor 164 enables the device 112 to track its orientation and movement over time (i.e. to track a pose of the device 112 over time). Motion tracking can be supplemented with data from the image sensor 148, in some examples, e.g. via motion tracking frameworks such as ARCore.

The memory 144 stores computer-readable instructions including an application 164. When executed by the processor 140, the application 164 configures the processor 140 to implement various functionality related to the receipt and processing of order collection data received from the server 104, and the generation of directional guidance to guide the collection of items to fulfill an order.

Those skilled in the art will appreciate that the functionality implemented by either or both of the processor 120 and the processor 140 via the execution of the applications 132 and 164 may also be implemented by one or more specially designed hardware and firmware components, such as FPGAs, ASICs and the like in other embodiments.

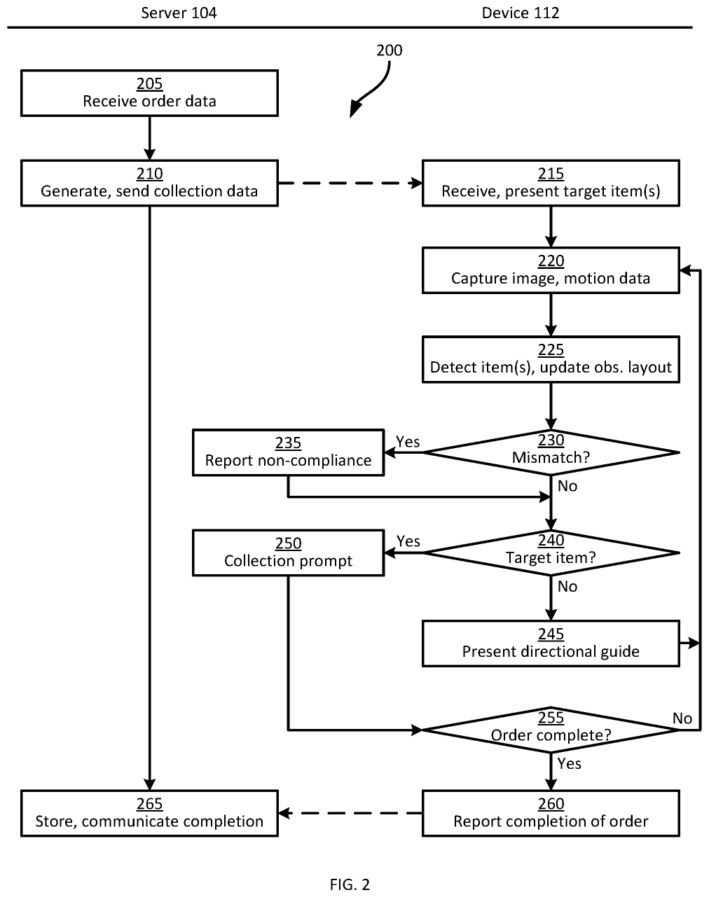

Turning now to FIG. 2, a method 200 for item collection guidance is illustrated. The method 200 will be discussed below in conjunction with its performance in the system 100, but it will be apparent to those skilled in the art that the method 200 may also be performed by other systems equivalent to that shown in FIG. 1. Certain blocks of the method 200 are illustrated as being performed by the server 104, while other blocks of the method 200 are illustrated as being performed by the device 112.

At block 205, the server 104 is configured to receive order data, e.g. from a customer computing device via the network 108. The order data includes at least one item identifier, and may also include a quantity for each identified item (e.g. counts, weights, volumes, etc.). The items identified in the order data are referred to as target items. As will be apparent to those skilled in the art, the order data may also include other parameters, such as a customer identifier, payment information and the like. Those other parameters are not shown herein for simplicity of illustration.

The server 104 can store the order data in the memory 124, e.g. in association with an order identifier. At block 210, the server 104 is configured to generate order collection data and send the order collection data to a mobile device for fulfillment of the order received at block 205. For example, the server 104 can select the mobile device 112 from a pool of available mobile devices, and transmit the order collection data to the selected device (e.g. the device 112).

The server 104 extracts the order collection data from the content of the repository 136. In general, the order collection data identifies the target items, and also includes data associated with additional items (referred to as non-target items). The non-target item data, although not directly required to fulfill the order, enables the device 112 to generate directional guidance for the operator of the device 112 in collecting the target items. The non-target item data may also enable the device 112 to detect misplaced items during order fulfillment.

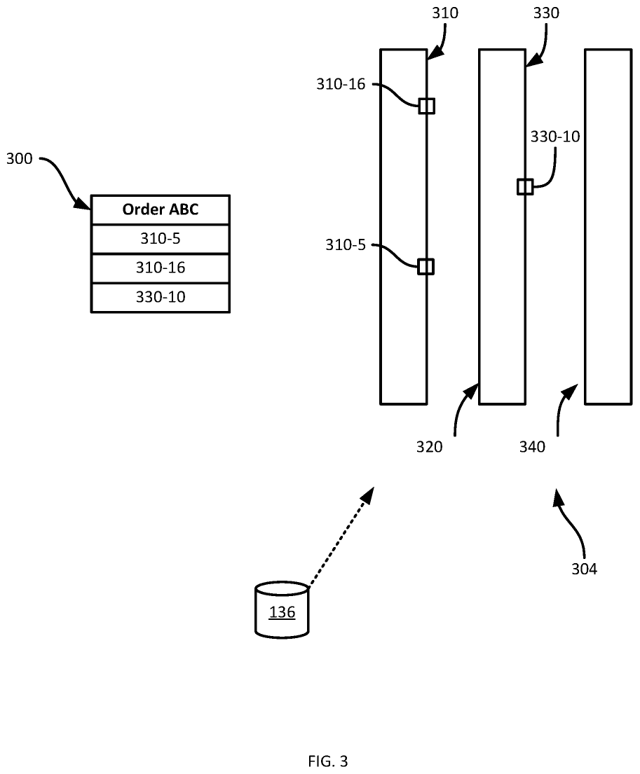

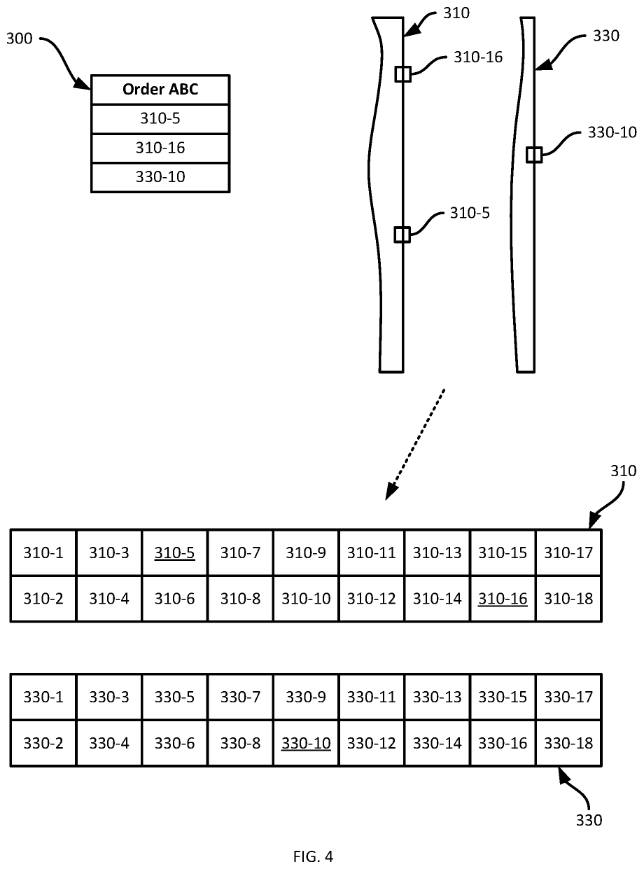

Turning to FIGS. 3 and 4, generation of the order collection data will be described in greater detail. FIG. 3 illustrates order data 300 received at block 205, including three item identifiers 310-5, 310-16, and 330-10. The item identifiers may be brand and product names, UPCs, or a combination thereof.

FIG. 3 also illustrates a reference layout 304, or planogram, as stored in the repository 136. The particular format in which the reference layout 304 need not be a graphical format, but can be implemented as a series of tables, a nodal data structure, or the like. The reference layout defines a plurality of regions in the facility, referred to as aisles in the present example. Specifically, the example facility illustrated includes four aisles 310, 320, 330, and 340. As will be apparent to those skilled in the art, the aisles are separated by corridors in which customers and workers can travel, and some aisles (e.g. the aisles 320 and 330) are placed back-to-back, without a corridor therebetween.

The reference layout 304 defines, for each of the aisles 310-340, reference locations of all the items in the relevant aisle. The locations may be specified as coordinates in a facility-wide frame of reference, an aisle-specific frame of reference, or the like. The reference layout 304 may include other data, such as a price, for each item in addition to the item identifier and location. The locations of the target items 310-5, 310-16 and 330-10 are illustrated on the reference layout 304. As shown in FIG. 3, the target items 310-5 and 310-16 are in the first aisle 310, while the target item 330-10 is in the third aisle 330.

The reference locations indicate the expected locations of the items within an aisle. In some cases, an item may be misplaced, out of stock, or the like. Such inventory errors are not reflected in the reference layout 304 itself, which represents instead a ground truth state of the facility. The device 112, as will be discussed in greater detail below, can detect mismatches between the actual arrangement of items in the facility and the reference layout 304, enabling the server 104 to initiate corrective actions to return the facility to a state that matches the reference layout 304.

The repository 316 also contains item recognition data, such as the above-mentioned neural network weights or other parameters defining image recognition mechanisms. Specifically, the repository 316 contains such parameters in association with each item in the reference layout 304. The item recognition data can be stored as part of the reference layout 304 itself, or in a separate file or set of files associated with the reference layout 304.

The reference layout 304 may be generated prior to performance of the method 200, for example via the receipt of input data at the server 104 from an operator to specify the identifiers and locations of items in the facility. The reference layout 304 may also be generated at the server 104 by receiving input data in the form of images of the aisles 310-340, e.g. collected by human workers carrying cameras, or by a mobile autonomous or semi-autonomous apparatus configured to travel along the aisles and capture such images. Based on the item recognition data, the server 104 can recognize items from such images and determine item locations based on the locations of the detected items in the images.

The item recognition data can be generated via any of a variety of suitable training processes. For example, the server 104 can be provided with sample images of each item in the facility (e.g. a plurality of images for each item, which may include images showing the item under various lighting conditions), as well as the identifier of the item. The server 104 can be configured to then determine the parameters (e.g. defining neural network nodes) enabling recognition of the item from subsequent images.

Turning to FIG. 4, to generate the order collection data transmitted to the device 112 at block 210, the server 104 extracts certain portions of the reference layout 304 and associated item recognition data. In particular, the server 104 is configured to determine, based on the reference layout 304, which aisle(s) contain each of the target items. The server 104 is then configured to retrieve portions of the reference layout 304 corresponding to each identified aisle. Thus, in the present example, the server 104 retrieves portions of the reference layout 304 corresponding to the aisles 310 and 330, without retrieving the remainder of the reference layout. The retrieved portions, as shown in the lower region of FIG. 4, indicate the item identifiers for both the target items and the non-target items in the relevant aisles (target item identifiers are underlined). In the illustrated example, the aisles are assumed to have an upper shelf and a lower shelf, and item locations are therefore shown both along the aisle, and according to whether the relevant item is on the upper or lower shelf.

The portions of the reference layout 304 shown in FIG. 4 are transmitted to the mobile device 112 at block 210, along with the target item identifiers from the order 300. The server 104 is also configured to send a portion of the item recognition data, corresponding to any items within the transmitted portions of the reference layout 304. That is, in the illustrated example, image recognition parameters for any item in the aisles 310 and 330 (not only the target items 310-5, 310-16, and 330-10) are transmitted to the device 112.

The data sent to the device 112 can be reformatted prior to transmission. For example, the server 104 can transmit the portions of the reference layout into a nodal data structure indicating item locations relative to one another, if the portions are not stored in such a nodal structure in the repository 136. In addition, the server 104 can convert the item recognition data to a format with reduced computational load (e.g. TensorFlow Lite).

Returning to FIG. 2, at block 215 the device 112 is configured to receive the order collection data from the server 104. For example, the device 112 can be configured to notify the server 104 when an operator has logged into the device 112, and the server 104 can transmit the order collection data allocated to that operator account to the device 112.

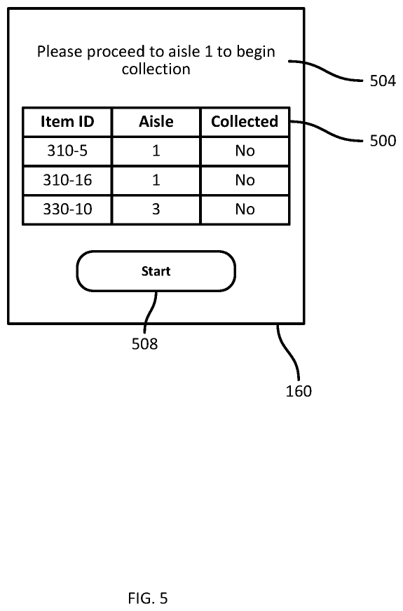

At block 215, the device 112 also presents at least one of the target items to the operator, e.g. via the display 160 or another suitable output device. Referring briefly to FIG. 5, the display 160 is shown at block 215. Specifically, the processor 140 controls the display 160 to present the target item identifiers, as well as regions (e.g. aisles) in which the items are expected to be located, and collection status indicators 500, indicating whether each item has been collected. The display 160 may also be controlled at block 215 to present an initial directional prompt 504 to the operator of the device 112, indicating the aisle in which the first listed item (e.g. the item 310-5) is located.

As also illustrated in FIG. 4, the device 112 presents an image capture command 508 on the display 160. The command 508, when selected, causes the device 112 to initiate functionality associated with block 220 of the method 200, including capturing at least one image (e.g. a stream of images) using the image sensor 148, as will be discussed below in greater detail. The command 508 need not be rendered on the display 160 in other examples. For example, an image capture operation may instead be initiated via activation of a hardware button, a voice command, or the like.

Returning to FIG. 2, at block 220 the device 112 is configured to capture at least one image, as well motion data. For example, the device 112 may begin capturing a stream of images and a stream of motion data at block 220, responsive to selection of the command 508 mentioned above. Each image frame captured at block 220 is processed to detect items therein as described below, substantially in real time. That is, the performance of the method 200 may include numerous performances of block 220, each of which is followed by performances of additional blocks discussed below, prior to the next performance of block 220. During the performance of block 220, the device 112 may also evaluate ambient light conditions via the captured images themselves or via another light sensor, and enable a flash or other illumination when ambient light levels fall below a threshold.

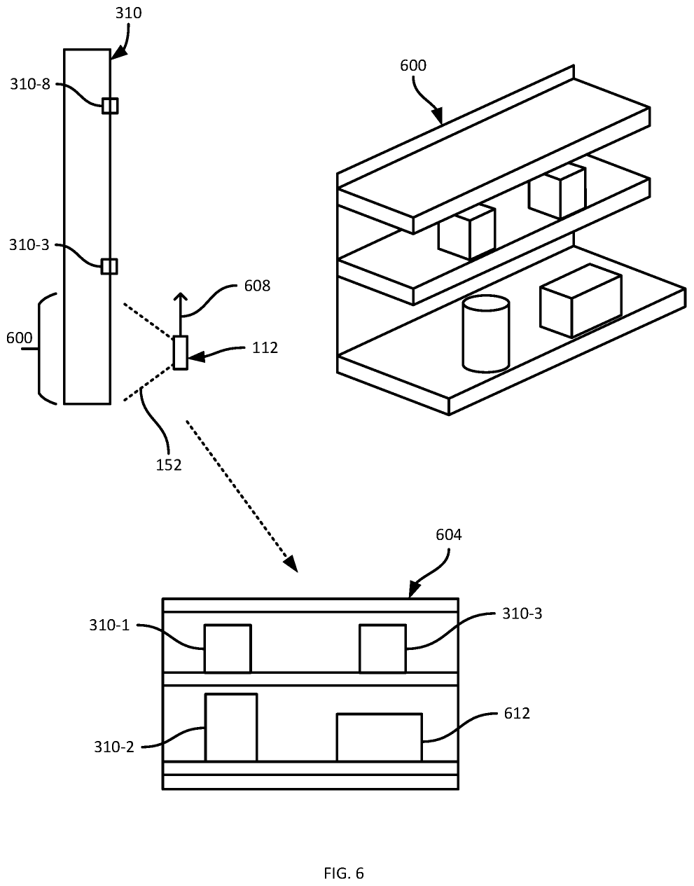

Turning to FIG. 6, an example performance of block 220 is illustrated. In particular, an overhead view of the aisle 310 is shown, with the device 112 oriented to aim the FOV 152 at the shelves of the aisle 310. The right-hand portion of FIG. 6 illustrates a portion 600 of the aisle 310 encompassed within the FOV 152, revealing that four items (two on each of the lower shelf and the upper shelf) are visible within the FOV 152.

At block 220, the device 112 captures an image 604, as well as motion data indicating a direction of travel 608 of the device 112. At block 225, the device 112 uses the item recognition data received from the server at block 215 to detect items from the image 604. For example, the device 112 may apply the item recognition data associated with the first aisle 310 to the image 604 to determine whether any items identifiable by the item recognition data are present in the image 604. In the present example, it is assumed that the items 310-1, 310-2, and 310-3 are present in the image 604. A fourth item 612 is also present in the image 604, but is not recognized. That is, the item 612 is not represented in the item recognition data, and may therefore have been misplaced from another aisle (e.g. the aisle 320, for which the device 112 did not receive item recognition data).

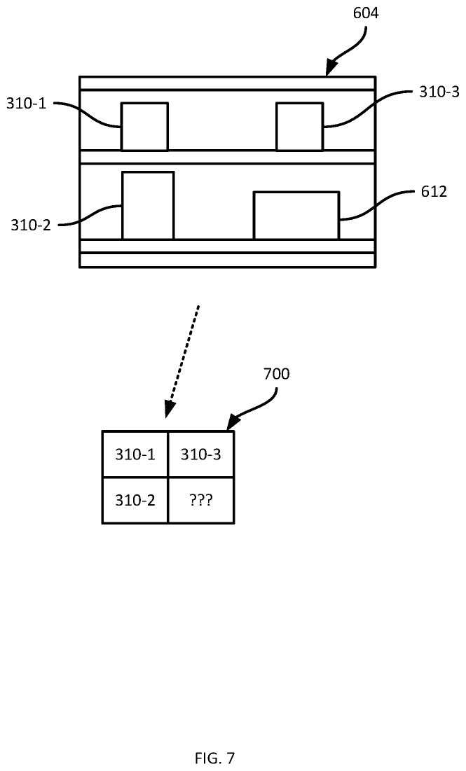

At block 225, the device 112 is also configured to update an observed layout. While the reference layout mentioned above defines the arrangement of items within the facility under ideal conditions, the observed layout defines the arrangement of items within the facility (or at least a portion thereof) as actually observed by the device 112 during item collection. In the first instance of block 225 illustrated in FIG. 6, the observed layout is constructed from the image 604 and the items detected therein. Turning to FIG. 7, an example observed layout 700 is illustrated, indicating relative positions of the items detected from the image 604. Because the item 612 could not be identified, no item identifier is present in the observed layout. Instead, the observed layout can contain a flag indicating the presence of an unidentified item.

Turning again to FIG. 2, at block 230 the device 112 is configured to determine whether there is a mismatch between the observed layout and the reference layout. The performance of block 230 thus involves comparing the observed layout 700 to the reference layout for the relevant aisle (the aisle 310, in the present example). The device 112 is therefore configured to identify a portion of the reference layout that corresponds to the observed layout. In the present example, the item identifiers 310-1, 310-2, and 310-3 and their positions relative to each other match the leftmost portion of the reference layout for the aisle 310. That portion of the reference layout is therefore compared to the observed layout 700 at block 230.

As will be apparent, the determination at block 230 in this example is affirmative, because where the reference layout indicates the item 310-4, the observed layout contains an unidentified item. Following an affirmative determination at block 230, the device 112 proceeds to block 235.

At block 235, the device 112 is configured to report a layout non-compliance. The device 112 may, for example, be configured to store the location (e.g. relative to other items in the observed layout 700, whose locations match the reference layout) of the mismatched item for subsequent reporting to the server 104. The device 112 may also store a status indicator in connection with the non-compliance report. For example, in the case of the item 612, the device 112 may report an indication of a plug (i.e. a misplaced item) at the expected location of the item 310-4. In other examples, e.g. if no item was detected in a given position, the non-compliance report can include an indication that the relevant item (as specified in the reference layout is out of stock).

Following a negative determination at block 230, or a performance of block 235, the device 112 proceeds to block 240. At block 240 the device 112 is configured to determine whether the image captured at block 220 contains a target item. The device 112 is thus configured to compare the item identifiers detected from the image 604 with the target items identified in the order data 300. In the present example performance of block 240, the determination at block 240 is negative, and the device 112 therefore proceeds to block 245.

At block 245, the device 112 is configured to present a directional guide to the operator of the device 112. The directional guide indicates a direction of travel from the current position of the device 112 (as inferred from the items within the FOV 152) towards the next target item to be collected. The device 112 determines the direction of travel by locating the portion of the aisle currently within the FOV 152 (e.g. via the comparison at block 230), and determining the expected location of the target item relative to that portion, from the reference layout received at block 215.

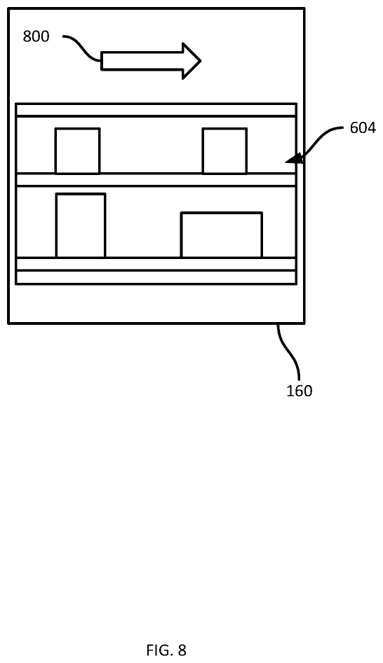

Turning to FIG. 8, the display 160 is shown at block 245, presenting the image 604 along with a directional guide 800 indicating a direction of travel towards the item 310-5. In some examples, the directional guide 800 can include an indication of the distance (e.g. in terms of a number of items, and/or a distance in meters, feet or the like) from the currently visible items (i.e. those in the FOV 152) to the target item. Other mechanisms for presenting the directional guide 800 are also contemplated, including audio output.

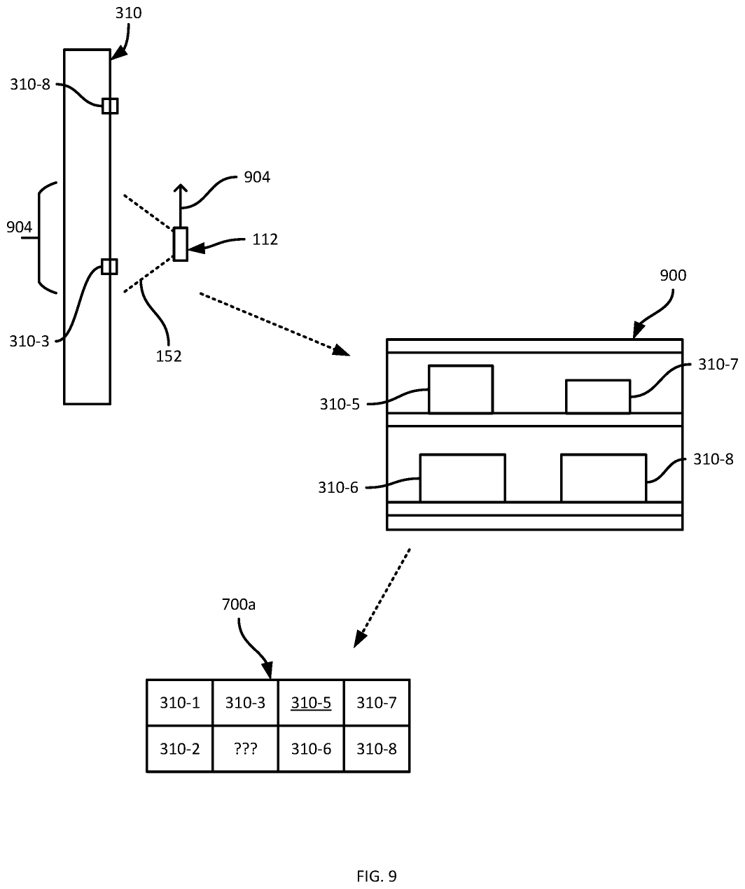

Following the performance of block 245, the device 112 returns to block 220 to capture a further image and further motion data as the operator travels along the aisle. Turning to FIG. 9, an image 900 is shown depicting a portion 904 of the aisle 310, as the device 112 has moved along the aisle from the position shown in FIG. 6. Motion data 904 indicates the direction of travel of the device 112.

At a further performance of block 225, the device 112 identifies the items 310-5, 310-6, 310-7, and 310-8 in the image 900, and generates an updated observed layout 700a. The updated observed layout 700a includes the observed layout 700 and the additional detected items. The additional items are placed in the observed layout 700a (relative to the original observed layout 700) based on the motion data 608 and 904. That is, the direction of travel of the device 112 between the capture of the image 604 and the image 900 determines the position of the additions to the observed layout 700a. In some implementations, the device 112 may detect that a rate of movement of the device 112 between image captures is sufficient to skip items, leaving gaps in the observed layout 700a. When such movement is detected, the device 112 may present an alert on the display or other output device, instructing the operator of the device 112 to travel more slowly.

At block 230, no additional mismatch is detected (beyond the mismatch discussed previously). The determination at block 230 is therefore negative, and the device 112 proceeds to block 240. At the current performance of block 240, the determination is affirmative because the item 310-5 is present in the FOV 152. The device 112 therefore proceeds to block 250, at which the device generates a prompt to collect the target item.

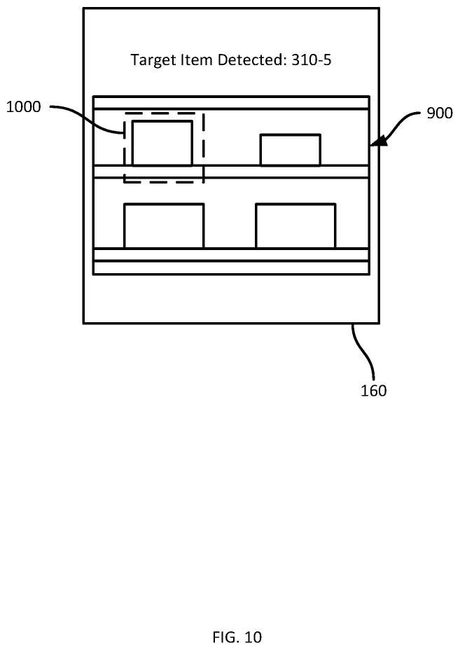

The prompt to collect the target item may include an identifier of the target item, and may also include an overlay on the image 900, as shown in FIG. 10. Specifically, FIG. 10 illustrates the display 160 at block 250, in which the image 900 is presented on the display 160 along with an overlay 1000 highlighting the position of the item 310-5 in the image 900 (which represents the current FOV 152 of the device 112). The collection prompt may also include other output data, such as audio output, vibration and the like.

Following generation of the collection prompt, the device 112 may await a barcode scan or other data capture operation indicating that the target item (e.g. the item 310-5, in this example) has been collected. The device 112 may then update the collection status identifier 500 (e.g. as shown in FIG. 5) associated with the item 310-5 to “yes” (or another suitable indication that the item has been collected).

Following completion of block 250, the device 112 proceeds to block 255 and determines whether the order is complete. The determination at block 255 is based on the collection status indicators 400, as updated via block 250. In the present example, the determination at block 255 is negative, and the device 112 therefore returns to block 220 to continue capturing image and motion data as described above.

When the determination at block 255 is affirmative, the device 112 reports completion of the order to the server 104 at block 260, e.g. by sending the order identifier and a completion flag or the like. The server 104, at block 265, may store the order completion report and initiate other actions, such as notifying a customer that the order is ready for pick up.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a mobile computing device, comprising:
obtaining order collection data containing (i) item identifiers corresponding to a set of target items and a set of non-target items, (ii) a reference layout indicating, within a region of a facility, respective positions of the target items and the non-target items, and (iii) item recognition data for the target items and the non-target items;
controlling an image sensor of the mobile computing device to acquire an image of a portion of the region;
based on the item recognition data, detecting an item from the image;
when the detected item is a target item, controlling an output assembly of the mobile computing device to present a prompt to collect the detected item; and
when the detected item is a non-target item, controlling the output assembly to present a directional guide towards a selected target item based on the reference layout.

2. The method of claim 1, further comprising:
controlling a display to present the acquired image;
wherein the prompt to collect the detected item includes an overlay on the image at the position of the detected item.

3. The method of claim 1, further comprising:
controlling a data capture module to scan the detected item; and
updating a collection status indicator associated with the detected item.

4. The method of claim 3, further comprising:
determining whether the collection status indicators of each of the target items indicate that the target items have been collected; and
when determination is affirmative, reporting completion to a server.

5. The method of claim 1, wherein controlling the output assembly to generate the directional prompt includes:
determining a position of the selected target item relative to the detected item from the reference layout; and
generating the directional prompt indicating a direction from the position of the detected item towards the position of the selected target item.

6. The method of claim 1, further comprising:
storing an item identifier of the detected item in an observed layout;
repeating the image sensor control and item detection to detect a further detected item; and
updating the observed layout with an item identifier of the further detected item.

7. The method of claim 6, further comprising:
determining the directional guide based on a comparison between the observed layout and the reference layout.

8. The method of claim 6, further comprising:
obtaining motion data from a motion sensor, the motion data indicating a direction of movement of the mobile computing device; and
determining a position of the further detected item based on the motion data.

9. The method of claim 6, further comprising:
determining that the observed layout does not match the reference layout; and
generating a non-compliance alert.

10. A computing device, comprising:
an image sensor;
an output assembly; and
a processor configured to:
obtain order collection data containing (i) item identifiers corresponding to a set of target items and a set of non-target items, (ii) a reference layout indicating, within a region of a facility, respective positions of the target items and the non-target items, and (iii) item recognition data for the target items and the non-target items;
control the image sensor to acquire an image of a portion of the region;
based on the item recognition data, detect an item from the image;
when the detected item is a target item, control the output assembly to present a prompt to collect the detected item; and
when the detected item is a non-target item, control the output assembly to present a directional guide towards a selected target item based on the reference layout.

11. The computing device of claim 10, wherein the processor is further configured to:
control a display of the output assembly to present the acquired image;
wherein the prompt to collect the detected item includes an overlay on the image at the position of the detected item.

12. The computing device of claim 1, wherein the processor is further configured to:
control a data capture module to scan the detected item; and
update a collection status indicator associated with the detected item.

13. The computing device of claim 3, wherein the processor is further configured to:
determine whether the collection status indicators of each of the target items indicate that the target items have been collected; and
when determination is affirmative, report completion to a server.

14. The computing device of claim 1, wherein the processor is further configured, in order to control the output assembly to generate the directional prompt, to:
determine a position of the selected target item relative to the detected item from the reference layout; and
generate the directional prompt indicating a direction from the position of the detected item towards the position of the selected target item.

15. The computing device of claim 1, wherein the processor is further configured to:
store an item identifier of the detected item in an observed layout;
repeat the image sensor control and item detection to detect a further detected item; and
update the observed layout with an item identifier of the further detected item.

16. The computing device of claim 6, wherein the processor is further configured to:
determine the directional guide based on a comparison between the observed layout and the reference layout.

17. The computing device of claim 6, further comprising: a motion sensor;
wherein the processor is further configured to:
obtaining motion data from the motion sensor, the motion data indicating a direction of movement of the mobile computing device; and
determine a position of the further detected item based on the motion data.

18. The computing device of claim 6, wherein the processor is further configured to:
determine that the observed layout does not match the reference layout; and
generate a non-compliance alert.

19. A non-transitory computer readable medium storing computer readable instructions executable by a processor to:
obtain order collection data containing (i) item identifiers corresponding to a set of target items and a set of non-target items, (ii) a reference layout indicating, within a region of a facility, respective positions of the target items and the non-target items, and (iii) item recognition data for the target items and the non-target items;
control an image sensor to acquire an image of a portion of the region;
based on the item recognition data, detect an item from the image;
when the detected item is a target item, control an output assembly to present a prompt to collect the detected item; and
when the detected item is a non-target item, control the output assembly to present a directional guide towards a selected target item based on the reference layout.
